(19) United States
(12) Patent Application Publication
(10) Pub. No.: US 2009/0039104 A1
(43) Pub. Date: Feb. 12, 2009

(54) Device and Method for Concurrently Dispensing Semi-Solid Products

(75) Inventors: Frank Edward Genewick, Ann Arbor, MI (US); Kenneth Paul McDonald, Wixom, MI (US)

Correspondence Address: WARN, HOFFMANN, MILLER & LALONE, .P.C, PO BOX 70098, ROCHESTER HILLS, MI, 48307, US

(73) Assignee: Elopak Systems AG

(21) Appl. No.: 11/792,565

(22) PCT Filed: Dec. 20, 2005
(86) PCT No.: PCT/GB05/04928

§ 371 Date: Apr. 29, 2008

Related U.S. Application Data
(60) Provisional application No. 60/637,563, filed on Dec. 20, 2004.

(51) Int. Cl. B65B 3/04; B67D 5/56; B65D 35/22

(52) U.S. Cl. 222/1; 222/144.5; 222/145.1; 222/145.3

(57) ABSTRACT

A device (10) for concurrently depositing different semi-solid products (12, 14) and 16 in a container (18) in respective vertically-oriented, distinct, homogeneous masses includes first and second inlet ports (24) and (26) provided at an upper end of a main filler tube (20) and first and second filler tube outlet ports disposed in a nozzle-form outlet opening (52) at a lower distal end of the main filler tube (20). A dividing insert is carried within the main filler tube (20) in a generally vertical orientation in a position separating the tube (20) into first and second channels. The first and second channels provide fluid communication between the first inlet port (24) and the first outlet port and between the second inlet port (26) and the second outlet port. The insert reorients the flow of first and second products (12) and (14) from respective upper azimuth positions at the inlet ports (24) and (26) to respective lower azimuth positions at the outlet ports, which are angularly offset from the upper azimuth positions.

This invention relates generally to a semi-solid product dispensing device for concurrently dispensing different semi-solid products, particularly such that the products are deposited in respective, distinct, homogeneous masses.

It is known to fill open-topped paperboard cartons with product dispensed from a filler tube in a carton forming, filling, and sealing machine. It is also known to adapt such a machine to dispense concurrently different semi-solid products into a carton such that the products are deposited in the carton in distinct, homogeneous masses. For example, a two-product filler tube for dispensing a two-component custard product in a carton forming, filling and sealing machine available from a member of the Elopak® Group of Companies is known as the Double Custard Filler Tube™.

The Double Custard Filler Tube™ includes a main, vertically-oriented filler tube including first and second diametrically-opposed inlet ports formed through an upper part of the circumferential side wall of the tube. A lower distal end of the tube includes a nozzle-form outlet opening positioned to dispense product into successive cartons.

A lifter mechanism raises each carton from a conveyor disposed below the main filler tube to a position encompassing a lower portion of the main filler tube. The lifter then lowers the carton at approximately the same rate that the main filler tube fills the carton.

Each of the first and second diametrically-opposed ports is offset 45 degrees from the direction of travel of the conveyor. A first supply tube is connected and provides fluid communication between a source outlet of a first product and the first port, which thus constitutes an outlet port of that supply tube. The source outlet is disposed in a direction from the first port generally parallel to the direction of travel of the conveyor. A second supply tube is connected and provides fluid communication between a source outlet of a second product and the second port, which thus constitutes an outlet port of that supply tube, the source outlet being disposed in a direction from the second port generally parallel to the direction of travel of the conveyor and, relative to the main filler tube, opposite the source outlet of the first product.

The first and second supply tubes include compound bend angles to re-orient the products so that, when the products are dispensed into cartons, the products are laterally separated transverse to the direction of conveyor travel. Such compound curves are used to re-orient product flow where, as is the case in many carton forming, filling, and sealing machines; source outlets are disposed in respective directions from the first and second ports generally parallel to the direction of travel of the conveyor.

A flat divider panel is carried within the main filler tube in a vertical orientation parallel to the direction of travel of the conveyor. The divider panel is positioned and shaped to separate the main filler tube into two semi-cylindrical channels to provide separate paths for the first and second products to follow as they descend through the main filler tube toward the outlet opening of the main filler tube. This allows the first and second products to exit through the opening without mixing and allows them to be deposited in cartons in respective homogenous masses on either side of a vertical plane aligned parallel to the direction of travel of the conveyor. With the two products oriented in this fashion within the cartons, and with the cartons oriented on the conveyor with their spouts opening either in or oppositely to the direction of conveyor travel, the two products will emerge side-by-side when the cartons are tipped in the directions of their spouts.

US-A-2002/0029819 discloses various embodiments of a nozzle for use in inserting toothpaste into toothpaste containers. In one embodiment, the nozzle includes an inner tube encircled by an outer tube, but with diametrically opposite dividing walls dividing the annular space between the inner and outer tubes into respective flow channels each of semi-circular cross-section, with a third, cylindrical flow channel being provided by the interior of the inner tube, so that white paste may be inserted by way of one of the outer channels, red gel may be inserted by way of the other outer channel and blue gel by way of the inner channel.

U.S. Pat. No. 4,184,613 discloses the production of a patterned product, such as ice cream, by forming a plurality of differing product streams, preferably three streams, into a patterned product stream having a desired cross-sectional pattern and dispensing the patterned product stream into a container. The apparatus includes a vertical, main filler tube to which extends radially a main horizontal tube to which extends perpendicularly two opposite, horizontal, product supply tubes for first and second products. The main horizontal tube may contain a three-vaned insert defining with the main horizontal tube two straight, horizontal, flow channels for the first and second products, respectively, and a third straight, horizontal, flow channel communicating with the interior of a tubular cap upon which the vanes are mounted and through which a third product is supplied to the third straight channel. The patterned product issuing from the main horizontal tube enters the main filler tube whence it is dispensed by the action of a dosing piston. In an alternative version, the insert has extending from its cap two parallel vanes which divide the interior of the main horizontal tube into three approximately parallel straight, horizontal, flow channels, an inner one of which is in the form of a diametral slot supplied with a first product from the interior of a tubular cap of the insert and the outer two of which are of segmental cross-section and supplied with second and third products from the respective transverse horizontal tubes. Although the preferred embodiment illustrated has three product inlet channels, that prior system is adaptable to utilise any number of two or more such flow channels each supplying a product of generally like consistency and temperature, for example different flavours of ice cream.

According to one aspect of the present invention, there is provided a semi-solid product dispensing device for concurrently dispensing differing semi-solid products, said device comprising:

a main filler tube having an outlet opening,

first and second product supply tubes extending to and communicating with said main filler tube at respective first and second inlet ports disposed substantially diametrically opposite each other at an upper end zone of said tube, and

a dividing member comprised of a downwardly extending vane serving to divide the interior of said tube into first and second substantially separate flow channels for the respective semi-solid products and in communication with the respective inlet ports,

characterized in that the azimuths of the outlet ends of the flow channels are angularly offset around said tube relative to the azimuths of the respective inlet ports.

According to a second aspect of the present invention, there is provided a method of dispensing semi-solid product, comprising supplying first and second semi-solid products to respective first and second flow channels arranged at respective opposite sides of a dividing member and substantially separate from each other, and guiding said semi-solid products in said flow channels such that the respective products are delivered from said flow channels at respective orientations angularly offset around a longitudinal axis of said dividing member relative to the orientations at which the respective products are supplied to said flow channels.

Owing to those aspects of the invention, it is possible to dispense two different semi-solid products concurrently from a main filler tube into cartons in respective homogeneous masses on respective sides of a vertical plane aligned parallel to the direction of conveyor travel without requiring multiple bend angles in the supply tubes delivering the products to the main filler tube.

According to a third aspect of the present invention, there is provided a semi-solid product dispensing device comprising a main filler tube the lower end of which serves to deliver product, first and second product supply tubes extending to and communicating with said main filler tube at respective first and second inlet ports disposed substantially diametrically opposite each other at an upper end zone of said main filler tube for supplying respective semi-solid products to said tube, and a dividing member comprised of a downwardly extending vane serving to divide the interior of said main filler tube into first and second substantially separate flow channels for the respective semi-solid products, said dividing member being mounted at said main filler tube so as to be turnable relative to said main filler tube about a longitudinal axis of said tube in order to change the angular orientation of the first and second flow channels about said axis.

According to a fourth aspect of the present invention, there is provided a method of dispensing semi-solid product, comprising supplying first and second semi-solid products to respective flow channels arranged side-by-side with each other and substantially separate from each other, and turning said flow channels simultaneously about a longitudinal axis to re-orientate the delivery of said semi-solid products.

Owing to those two aspects of the invention, it is possible to re-orientate the delivery of semi-solid products without needing to remove a dividing member from a main filler tube.

According to a fifth aspect of the present invention, there is provided a range of members for obturating an upper end of a main filler tube of a semi-solid product dispensing device, the lower end of which serves to deliver product, comprising:—

a first dividing member comprised of a downwardly extending vane for dividing the interior of said main filler tube into first and second substantially separate flow channels for first and second semi-solid products respectively, and also comprised of a middle flow channel separate from, but extending generally longitudinally of, said first and second flow channels and for a third semi-solid product;

a second dividing member comprised of a downwardly extending vane for dividing the interior of said main filler tube into separate flow channels for two respective semi-solid products and without any flow channel therethrough;

and a capping member for allowing a single semi-solid product to flow through the whole of the cross-sectional area of the interior of said main filler tube.

According to a sixth aspect of the present invention, there is provided a method of obturating an upper end of a main filler tube of a semi-solid product dispensing device, the lower end of which serves to deliver product, comprising selecting one of:—

a first dividing member comprised of a downwardly extending vane and a middle flow channel extending longitudinally of said vane and separate from the ambient atmosphere at respective opposite major surfaces of said vane,

a second dividing member comprised of a downwardly extending vane, without any flow channel therethrough, and

a capping member, and,

in the event of selection of:—

said first dividing member, inserting the latter into said upper end and thereby dividing the interior of said main filler tube into first and second substantially separate flow channels for first and second semi-solid products, with said middle flow channel being for a third semi-solid product,

said second dividing member, inserting the latter into said upper end and thereby dividing the interior of said main filler tube into first and second separate flow channels for first and second semi-solid products, without any further flow channel in said interior, or

said capping member, applying the latter to said upper end.

Owing to those two aspects of the invention, it is possible to cope not only with filling two or three semi-solid products at a filler, but also with filling a single such product at the filler, without any difficulty.

In a preferred embodiment of the invention, a semi-solid product dispensing device concurrently dispenses different semi-solid products into a container such that the products are deposited in the container in respective vertically-oriented, distinct, homogeneous masses. The device includes a main filler tube arranged to be installed in a carton filling machine. The main filler tube includes first and second supply tube outlet ports (and thus filler tube inlet ports) formed through an upper side wall of the main filler tube. First and second filler tube outlet ports are disposed in an outlet opening at a lower distal end of the tube. A dividing insert is carried within the main filler tube in a generally vertical orientation in a position separating the filler tube into first and second channels. The first channel provides fluid communication between the first filler tube inlet port and the first filler tube outlet port. The second channel provides fluid communication between the second filler tube inlet port and the second filler tube outlet port. The dividing insert is configured to reorient the flow of the first and second products from respective upper azimuth positions at the filler tube inlet ports to respective lower azimuth positions at the filler tube outlet ports. The lower azimuth positions of the filler tube outlet ports are offset from the upper azimuth positions.

In order that the invention may be clearly and completely disclosed, reference will now be made, by way of example, to the accompanying drawings, in which:

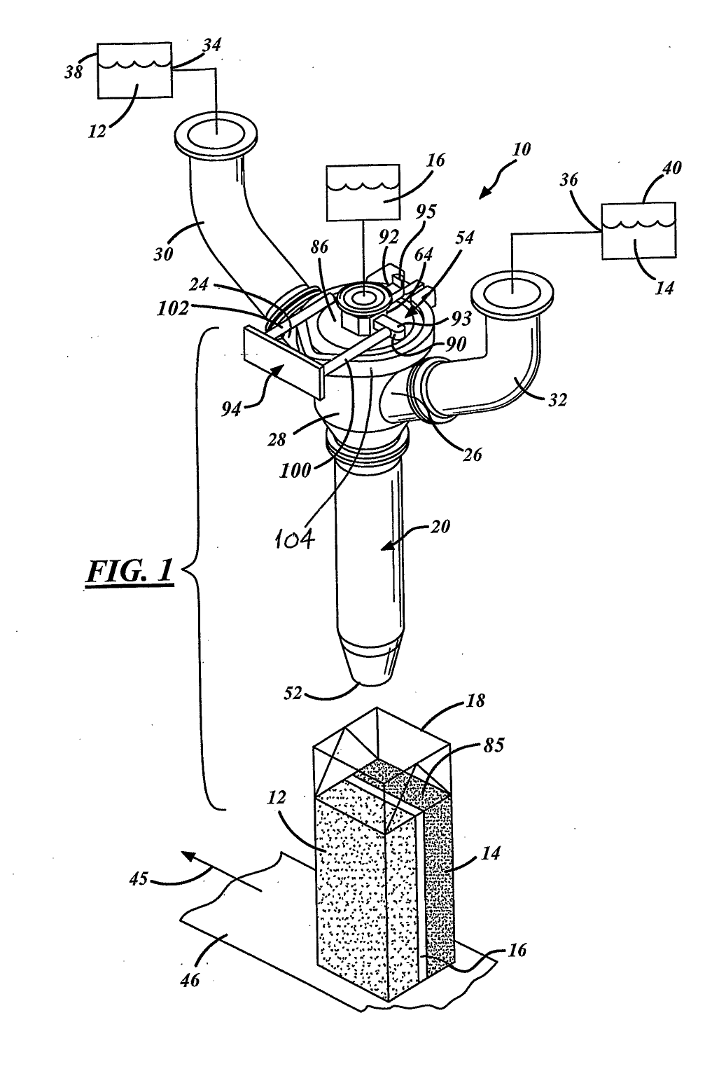

FIG. 1 is an orthogonal view of a semi-solid product dispensing device shown positioned above a container and with a dividing insert of the device orientated in a position to dispense three different products in parallel layers aligned with a conveyor direction of travel;

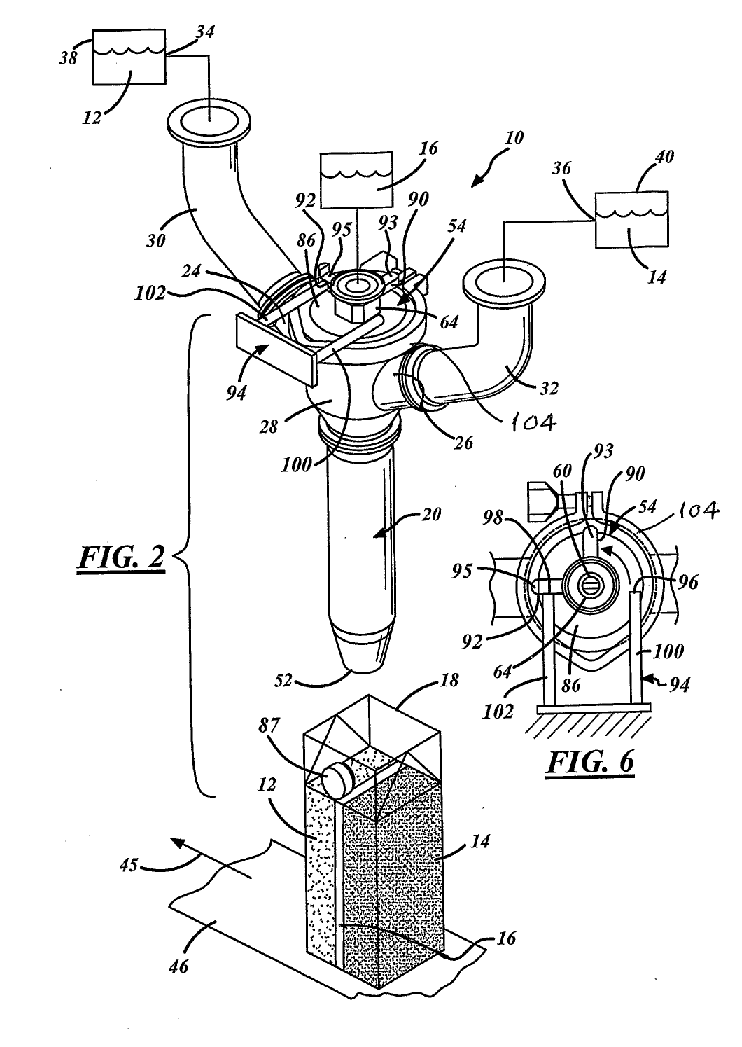

FIG. 2 is a view similar to FIG. 1, but with the dividing insert re-orientated to a position to dispense the three products in parallel layers transverse to the conveyor direction of travel;

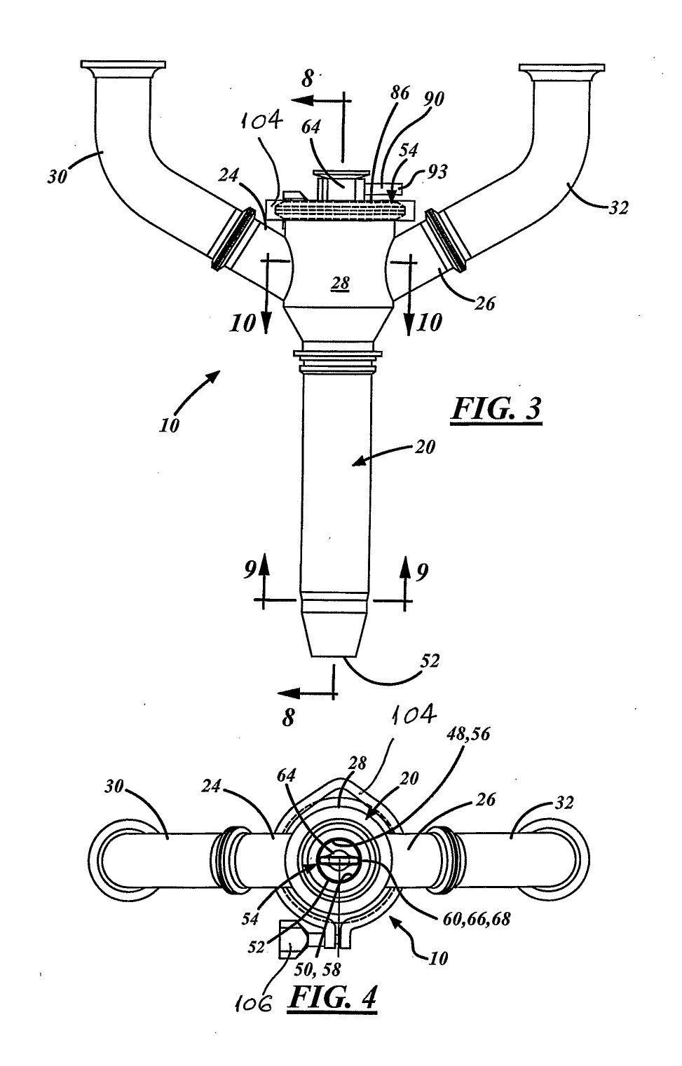

FIG. 3 is a side elevation of the device;

FIG. 4 is an underneath plan view of the device;

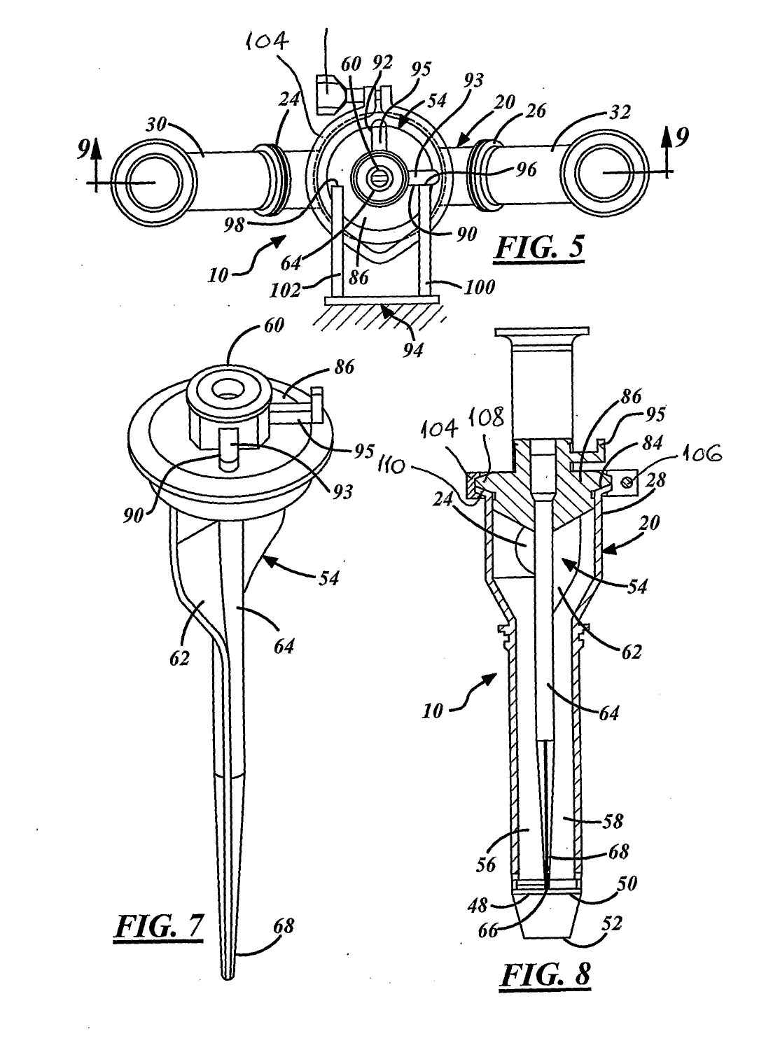

FIG. 5 is a top plan view of the device;

FIG. 6 is a partial top plan view of the device showing the dividing insert re-orientated to the position shown in FIG. 2;

FIG. 7 is an orthogonal view of the three-product dividing insert;

FIG. 8 is a longitudinal sectional view of the device taken along the line 8-8 of FIG. 3;

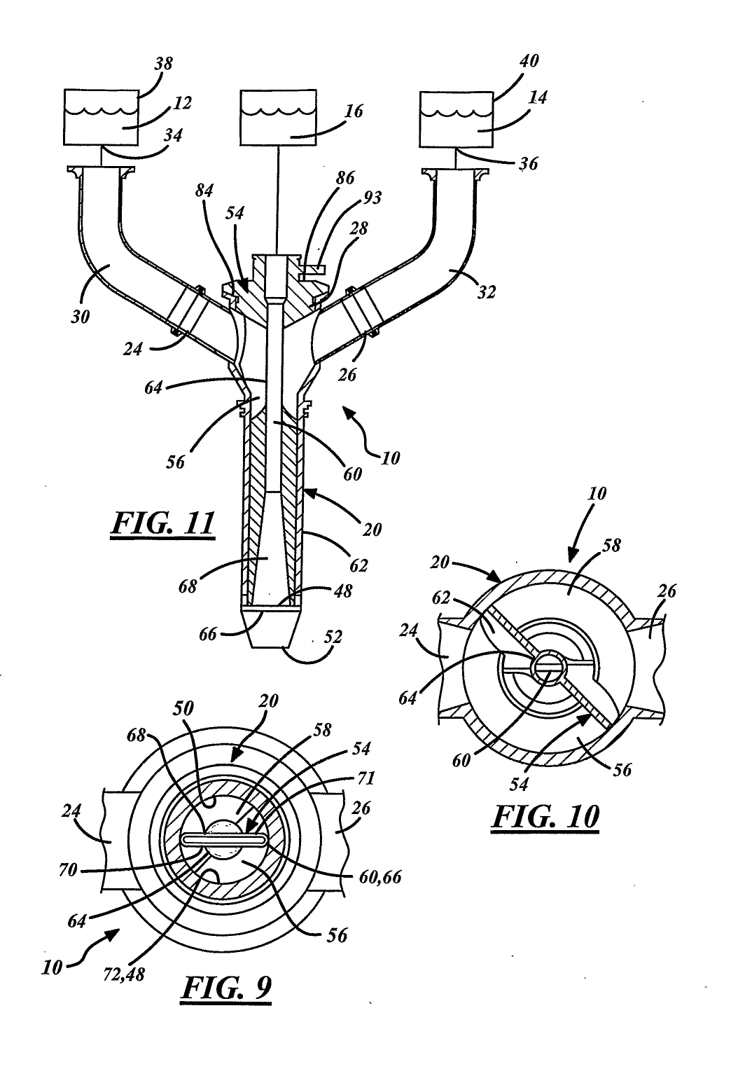

FIG. 9 is a cross-sectional view of the device taken along the line 9-9 of FIG. 3;

FIG. 10 is a cross-sectional view of the device taken along the line 10-10 of FIG. 3;

FIG. 11 is a longitudinal sectional view of the device taken along the line 11-11 of FIG. 5;

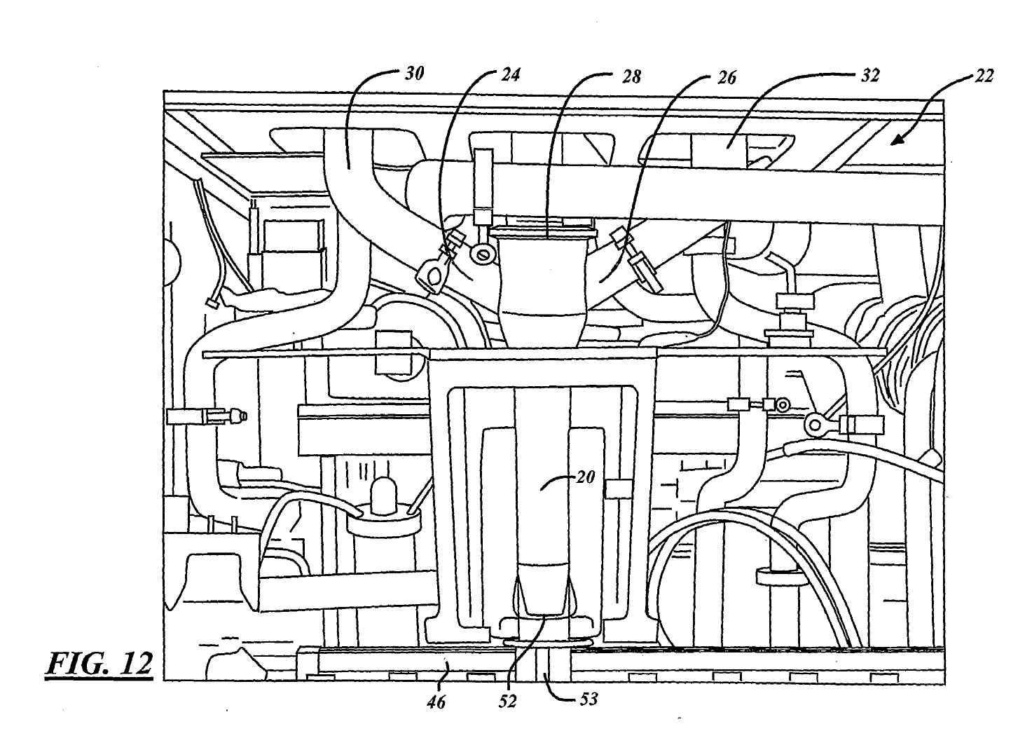

FIG. 12 is a side elevation of the device installed in a carton forming, filling, and sealing machine;

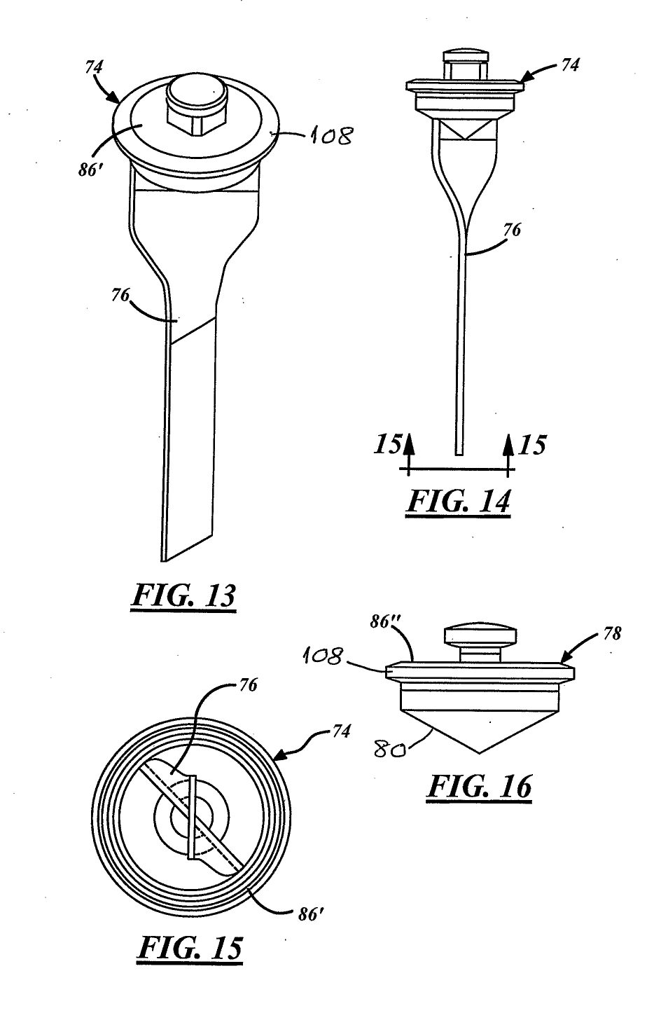

FIG. 13 is an orthogonal view of an optional two-product dividing insert interchangeable with the three-product dividing insert;

FIG. 14 is a side elevation of the two-product dividing insert;

FIG. 15 is an underneath plan view of the two-product dividing insert; and

FIG. 16 is an elevation of an optional single-product insert interchangeable with the two- and three-product dividing inserts.

Referring to FIGS. 1 to 12, a device 10 for concurrently dispensing different semi-solid products 12, 14 and 16 into a container 18 such that the products 12, 14 and 16 are deposited in the container 18 in respective vertically-oriented, distinct, homogeneous masses, is generally illustrated. As shown in FIGS. 1 to 5 and 8 to 12, the device 10 includes a main filler tube 20 for installation in a generally vertical orientation in a carton forming, filling, and sealing machine 22. The main filler tube 20 includes first and second filler tube inlet ports 24 and 26 formed through diametrically-opposite sides of a circumferential upper side wall part 28 of the main filler tube 20. First and second supply tubes 30 and 32 connect respective first and second filler tube inlet ports 24 and 26 (which in effect also constitute supply tube outlet ports) to first and second product source outlets 34 and 36 of the forming, filling, sealing machine 22 as shown in FIGS. 1, 2, 11, and 12. The first and second product source outlets 34 and 36 lead from first and second product source tanks shown at 38 and 40, respectively, in FIGS. 1, 2, and 11. The first and second product source tanks 38 and 40 contain the first and second semi-solid products 12 and 14, respectively.

The first supply tube 30 is connected at an inner end to the port 24 and has an outer end connectable to the first product source outlet 34. The first supply tube 30 provides fluid communication between the first product source outlet 34 and the port 24 so that the first product 12 can flow from the first product source tank 38 to the main filler tube 20. As will be understood from FIGS. 1 and 12, when the device 10 is installed in a forming, filling, and sealing machine 22, the first product source outlet 34 is disposed in a direction from the port 24 generally parallel to the direction of travel 45 of a conveyor 46 that is serially presenting containers 18 for the device 10 to fill.

The second supply tube 32 is connected at an inner end to the port 26 and has an outer end that is connectable to the second product source outlet 36. The second supply tube 32 provides fluid communication between the second product source outlet 36 and the port 26 so that the second product 14 can flow from the second product source tank 40 to the main filler tube 20. As will be understood from FIGS. 1 and 12, when the device 10 is installed in a forming, filling, sealing machine 22 the second product source outlet 36 is disposed in a direction from the port 26 generally parallel to the direction of travel 45 of the conveyor 46.

First and second filler tube outlet ports; shown at 48 and 50, respectively, in FIGS. 4, 8, and 9, are disposed in a nozzle-form outlet opening 52 at a lower, distal end of the main filler tube 20 to dispense the first and second products 12 and 14 into successive open-topped containers 18 in the form of plastics-coated paperboard cartons 18 as the cartons pass by on the conveyor 46 disposed below the main filler tube 20. As each carton 18 moves into a position directly below the main filler tube 20, the conveyor 46 pauses, and a lifter, shown at 53 in FIG. 12, raises the carton 18 from the conveyor 46 to a position encompassing a lower portion of the main filler tube 20. The lifter 53 then lowers the carton 18 at the same approximate rate that the main filler tube 20 fills the carton 18 with the products 12, 14 and 16.

A three-product dividing insert, best shown at 54 in FIG. 7, is carried within the main filler tube 20 as shown in FIGS. 8 to 11. The main filler tube 20 carries the insert 54 in a generally vertical orientation in a position separating the filler tube 20 into first, second, and third channels 56, 58 and 60 as best shown in FIGS. 4 and 8 to 10. The first channel 56 provides fluid communication between the port 24 and the filler tube outlet port 48 for passage of the first product 12. The second channel 58 provides fluid communication between the port 26 and the filler tube outlet port 50 for passage of the second product 14. In this way, the first and second channels 56 and 58 provide separate paths for the first and second products 12 and 14 to follow as they descend through the main filler tube 20 from the ports 24 and 26 toward the respective ports 48 and 50. This allows the first and second products 12 and 14 to pass through and exit the filler tube 20 without mixing with one another and allows them to be deposited in cartons in respective, distinct, homogenous masses as shown in FIG. 1. As is also best shown in FIG. 1, the distinct homogeneous masses are deposited within each carton on either side of an imaginary vertical plane aligned parallel to the direction of travel of the conveyor 46. With the first and second products 12 and 14 oriented in this fashion within each carton, and with each carton oriented on the conveyor 46 with respective carton spouts opening either in or oppositely to the direction of conveyor travel, once the carton spouts have been opened, the first and second products 12 and 14 will emerge side-by-side when the cartons are tipped in the directions of their respective spouts.

The three-product dividing insert 54 includes a helically-shaped panel or vane, best shown at 62 in FIG. 7, that reorients the flow of the first and second products 12 and 14 from respective upper azimuth positions at the ports 24 and 26 to respective lower azimuth positions at the ports 50 and 48. The lower azimuth positions of the ports 48 and 50 are angularly offset from the upper azimuth positions so that the ports 24 and 26 can be aligned parallelly to the direction of travel of the conveyor 46 rather than being offset approximately one half of one right-angle, in particular 45 degrees, in azimuth as would otherwise be necessary because of constraints of product source tank and supply tube locations. This allows the first and second supply tubes 30 and 32 to be aligned in one plane (rather than having compound curves) in carton filling machines, such as the one shown in FIG. 12, having product source outlets 34 and 36 disposed in respective directions from the ports 24 and 26 generally parallel to the direction of travel of the conveyor 46. Such compound bends and the additional tube lengths required for the bends can break down the viscosity of semi-solid shear-sensitive products. The somewhat helical shape of the dividing insert panel 62 therefore allows the product supply tubes 30 and 32 to be formed and attached to the filler tube 20 in a single plane, and thus easier to manufacture.

The panel 62 of the insert 54 has an approximate 45 degree twist along its length and, as best shown in FIG. 10, is positioned within the filler tube 20 such that its upper end is offset approximately an additional one half of one right-angle, in particular 45 degrees, in azimuth from the horizontal flow direction of the first and second products 12 and 14 as they enter the main filler tube 20. Accordingly, a lower end of the panel 62 is oriented generally parallel to the direction of travel of the conveyor 46, and the panel 62 thus reorients the flow of the first and second products 12 and 14 approximately one right-angle, in particular 90 degrees, from the respective “fore-aft” upper azimuth positions at the ports 24 and 26 to respective “side-by-side” lower azimuth positions at the ports 50 and 48, the lower azimuth positions being offset 90 degrees from the upper azimuth positions.

The three-product dividing insert 54 also includes an axial tube shown at 64 in FIGS. 1 to 11. The axial tube 64 runs down a vertical central axis of the panel 62 and carries a third semi-solid product 16 such as a syrup to a third outlet port 66 disposed between the first and second outlet ports 48 and 50. The axial tube 64 allows a thin layer of the third product 16 to be deposited in each carton between the first and second products 12 and 14, as shown in FIG. 1.

The axial tube 64 of the insert 54 has a flattened and flared lower end portion as shown at 68 in FIGS. 4, 7 to 9, and 11. As shown in FIGS. 4, 7 to 9, and 11 the flared lower end portion 68 diametrically spans the opening 52. At its distal lower end, first and second generally parallel outer surfaces 70 and 71 of the flared lower end portion 68 define, along with an inner circumferential surface 72 of the opening 52, the first and second outlet ports 48 and 50, respectively, as is best shown in FIG. 9. Each outlet port 48 and 50 is generally half-circular in shape and has a radius generally equal to half the inside diameter of the opening 52. The flared lower end portion 68 of the axial tube 64 defines the third outlet port 66 as an elongated slit diametrically substantially spanning the opening 52 and generally diametrically co-extensive with the first and second outlet ports 48 and 50 so that when all three products 12, 14 and 16 exit the main filler tube 20 they have the same width as each other. In the present example, the product ratio of the first to the second to the third product is 45-45-10.

The main filler tube 20 allows for the removal of the three-product dividing insert 54 and for the removable installation of an insert having a different configuration from that of the insert 54. Interchangeable inserts may include a two-product or “double filler” insert shown at 74 in FIGS. 13 to 15. The two-product insert 74 includes a twisted dividing panel 76 but no axial tube. Another optional, interchangeable insert is a single-product insert as shown at 78 in FIG. 16. The single-product insert 78 has neither a dividing panel nor an axial tube. Instead, the single-product insert 78 is shaped to provide maximum surface area for guiding the flow of a single product entering from both of the first and second supply tubes 30 and 32. A downwardly converging, conical lower surface 80 of the single-product insert 78 reduces shear resistance from that to which the single product would be exposed if using either of the inserts 54 and 74 to fill cartons with a single product.

The three-product and two-product inserts 54 and 74 are rotatable within the main filler tube 20 to change the azimuth positions of the outlet ports 48 and 50 relative to the inlet ports 24 and 26 to alter product layer alignment relative to carton conveyor direction of travel. More specifically, the three- and two-product inserts 54 and 74 are rotatable within the main filler tube 20 between a first dividing position shown in FIGS. 1, 3 to 5, and 8 to 11 and a second dividing position shown in FIGS. 2 and 6. In the first dividing position the azimuth positions of the outlet ports 48 and 58 are offset by approximately 90 degrees from the azimuth positions of the respective ports 24 and 26. In the second dividing position the azimuth positions of the outlet ports 50 and 48 are aligned with the azimuth positions of the respective ports 24 and 26.

Accordingly, with either the three-product or the two-product insert 54, 74 in the first dividing position, the dispensed product layers will be aligned with, i.e. parallel to, the carton conveyor direction of travel. This product orientation is suitable for a carton form-fill-seal machine producing cartons not having pour spout fitments, which are usually applied transversely of the direction 45, and oriented with the pour spout panels 85 of their gable-tops positioned in line with conveyor feed as shown in FIG. 1.

With either of these inserts 54 and 74 in the second dividing position, the dispensed product layers will be oriented transversely to the carton conveyor direction of travel. This product orientation is suitable for a carton form-fill-seal machine producing cartons having pour spout fitments 87 applied transversely to conveyor flow, as shown in FIG. 2.

Each insert 54 or 74 includes a circular cap 86 or 86′ that closes an upper, circular, insert-receiving opening 84 of the main filler tube 20 and also includes first and second stop surfaces 90 and 92, turnable with that cap, as best shown in FIGS. 5 and 6. The first and second turnable stop surfaces 90 and 92 are disposed on respective stop arms best shown at 93 and 95 in FIGS. 5 and 6. The device includes a stop bracket 94 including first and second stationary stop surfaces shown at 96 and 98 in FIGS. 5 and 6. The stop surfaces 96 and 98 are disposed on respective stationary stop rods shown at 100 and 102 in FIGS. 1, 2, 5, and 6. The first stationary stop surface 96 is positioned to arrest turning movement of the insert 54 or 74 in the first dividing position when contacted by the first turnable stop surface 90. The second stationary stop surface 98 is positioned to arrest turning movement of the insert 54 or 74 in the second dividing position when contacted by the second turnable stop surface 92. As shown schematically in FIGS. 5 and 6, the stop bracket 94 is supported on a fixed structure.

To retain the insert 54, 74 or 78 against lifting relative to the tube 20 under the pressure of product fed to that tube, and also to prevent leakage of product from the tube 20 past the circular cap 86, 86′ or 86″ of the insert 54, 74 or 78, the device includes a readily releasable ring clamp 104 having a clamping screw 106. The loop of the clamp 104 is of substantially U-shaped cross-section with its limbs diverging radially inwardly, so as to embrace the peripheral run 108 of the cap 86, 86′ or 86″ and an upwardly and outwardly flared annular lip 110 of the upper extremity of the tube 20, and to squeeze the rim 108 sealingly against the lip 110. The ring clamp 104 also releasably retains the insert 54 or 74 against turning out of its set first dividing position or second dividing position.

We claim:

1-31. (canceled)

32. A semi-solid product dispensing device for concurrently dispensing differing semi-solid products, said device comprising:
a main filler tube having an outlet opening, first and second product supply tubes extending to and communicating with said main filler tube at respective first and second inlet ports disposed substantially diametrically opposite each other at an upper end zone of said tube, and
a dividing member comprised of a downwardly extending vane serving to divide the interior of said tube into first and second substantially separate flow channels for the respective semi-solid products and in communication with the respective inlet ports,
wherein the azimuths of the outlet ends of the flow channels are angularly offset around said tube relative to the azimuths of the respective inlet ports.

33. A device according to claim 32, in which said vane includes a twist of approximately one half of a right-angle along its length and is positioned within said tube such that its lower end is offset approximately one half of a right-angle around a longitudinal axis of said vane relative to an upper end of said vane.

34. A device according to claim 32, in which the first and second inlet ports are formed through diametrically opposite sides of an upper side wall of said tube.

35. A device according to claim 32, in which said dividing member includes a middle flow channel arranged to carry a third product to a third outlet end disposed between the first and second outlet ends.

36. A device according to claim 35, in which the axial channel includes a flattened and flared lower end which diametrically substantially spans said outlet opening and at which are first and second outer surfaces that, along with an inner circumferential surface of said outlet opening, define the first and second outlet ends, respectively.

37. A device according to claim 32, in which the main filler tube is arranged to allow removal of the dividing member and installation of a dividing member of a different configuration.

38. A device according to claim 32, in which the dividing member is turnable in the main filler tube about a longitudinal axis of that tube to change the angular positions of the azimuths of the outlet ends of the flow channels relative to the azimuths of the inlet ports.

39. A device according to claim 38, in which the dividing member is turnable as aforesaid between a first dividing position in which the azimuths of the outlet ends of the flow channels are offset by approximately one right-angle from the azimuths of the first and second inlet ports and a second dividing position in which the azimuths of the outlet ends of the flow channels are not offset therefrom.

40. A device according to claim 39, in which said dividing member includes a cap that closes the upper end of the main filler tube and includes first and second turnable stop surfaces turnable therewith, and said device includes a first stationary stop surface positioned to arrest turning movement of the dividing member in said first dividing position by co-operation with the first turnable stop surface and a second stationary stop surface positioned to arrest turning movement of the dividing member in said second dividing position by co-operation with the second turnable stop surface.

41. A device according to claim 32, and further comprising a single-product capping member for the upper end of said main filler tube and interchangeable with said dividing member.

42. A device according to claim 41, wherein said capping member is shaped to supplement the surface area for guiding the flow of a single product through the main filler tube.

43. A device according to claim 42, in which the capping member includes a downwardly converging, conical lower surface.

44. A device according to claim 41, in which the capping member is shaped to supplement the surface area for guiding the flow through the main filler tube of a single product entering from both of the first and second supply tubes.

45. A device according to claim 32 and further comprising a ring clamp for readily releasably retaining said dividing member or said capping member sealingly in position relative to said main filler tube.

46. A method of dispensing semi-solid product, comprising supplying first and second semi-solid products to respective first and second flow channels arranged at respective opposite sides of a dividing member and substantially separate from each other, and guiding said semi-solid products in said flow channels such that the respective products are delivered from said flow channels at respective orientations angularly offset around a longitudinal axis of said dividing member relative to the orientations at which the respective products are supplied to said flow channels.

47. A method according to claim 46 and further comprising supplying a third semi-solid product to a third flow channel in said dividing member and intermediate, but substantially separate from, said first and second flow channels, so that said third semi-solid product is delivered to between said first and second products.

48. A method according to claim 46, and further comprising changing the angular positions of said dividing member and thus of said flow channels about said longitudinal axis relative to a main filler tube containing said flow channels.

49. A method according to claim 48, wherein said angular positions are changed as aforesaid by substantially one right-angle.

50. A method according to claim 48, and further comprising replacing said dividing member by a dividing member having a different configuration for a different plurality of semi-solid products or by a capping member for a single semi-solid product.

51. A semi-solid product dispensing device comprising a main filler tube the lower end of which serves to deliver product, first and second product supply tubes extending to and communicating with said main filler tube at respective first and second inlet ports disposed substantially diametrically opposite each other at an upper end zone of said main filler tube for supplying respective semi-solid products to said tube, and a dividing member comprised of a downwardly extending vane serving to divide the interior of said main filler tube into first and second substantially separate flow channels for the respective semi-solid products, said dividing member being mounted at said main filler tube so as to be turnable relative to said main filler tube about a longitudinal axis of said tube in order to change the angular orientation of the first and second flow channels about said axis.

52. A device according to claim 51, wherein the dividing member is turnable as aforesaid between a first dividing position in which the azimuths of the outlet ends of the flow channels are offset by approximately one right-angle from the azimuths of the first and second inlet ports and a second dividing position in which the azimuths of the outlet ends of the flow channels are not offset therefrom.

53. A device according to claim 52, wherein said dividing member includes a cap that closes the upper end of the main filler tube and includes first and second turnable stop surfaces turnable therewith, and said device includes a first stationary stop surface positioned to arrest turning movement of the dividing member in said first dividing position by co-operation with the first turnable stop surface and a second stationary stop surface positioned to arrest turning movement of the dividing member in said second dividing position by co-operation with the second turnable stop surface.

54. A device according to claim 51, and further comprising a ring clamp for readily releasably retaining said dividing member sealingly in position relative to said main filler tube.

55. A method of dispensing semi-solid product, comprising supplying first and second semi-solid products to respective flow channels arranged side-by-side with each other and substantially separate from each other, and turning said flow channels simultaneously about a longitudinal axis to re-orientate the delivery of said semi-solid products.

56. A method according to claim 55, wherein said delivery is re-orientated as aforesaid through substantially one right-angle.

57. A range of members for obturating an upper end of a main filler tube of a semi-solid product dispensing device, the lower end of which serves to deliver product, comprising:
a first dividing member comprised of a downwardly extending vane for dividing the interior of said main filler tube into first and second substantially separate flow channels for first and second semi-solid products respectively, and also comprised of a middle flow channel separate from, but extending generally longitudinally of, said first and second flow channels and for a third semi-solid product;
a second dividing member comprised of a downwardly extending vane for dividing the interior of said main filler tube into separate flow channels for two respective semi-solid products and without any flow channel therethrough; and
a capping member for allowing a single semi-solid product to flow through the whole of the cross-sectional area of the interior of said main filler tube.

58. A range according to claim 57, wherein each vane includes a twist of approximately one half of one right-angle along its length.

59. A range according to claim 57, wherein said middle flow channel includes a flattened and flared lower end.

60. A range according to claim 57, wherein each dividing member includes a cap which includes first and second stop surfaces fixed relative to the dividing member.

61. A range according to claims 57, wherein said capping member includes a downwardly converging, conical lower surface.

62. A method of obturating an upper end of a main filler tube of a semi-solid product dispensing device, the lower end of which serves to deliver product, comprising selecting one of:
a first dividing member comprised of a downwardly extending vane and a middle flow channel extending longitudinally of said vane and separate from the ambient atmosphere at respective opposite major surfaces of said vane,
a second dividing member comprised of a downwardly extending vane, without any flow channel therethrough, and
a capping member, and,
in the event of selection of:
said first dividing member, inserting the latter into said upper end and thereby dividing the interior of said main filler tube into first and second substantially separate flow channels for first and second semi-solid products, with said middle flow channel being for a third semi-solid product,
said second dividing member, inserting the latter into said upper end and thereby dividing the interior of said main filler tube into first and second separate flow channels for first and second semi-solid products, without any further flow channel in said interior, or
said capping member, applying the latter to said upper end.
